(19) United States
(12) Patent Application Publication
(10) Pub. No.: US 2013/0076669 A1
(43) Pub. Date: Mar. 28, 2013

(54) PORTABLE TERMINAL AND RECEPTION CONTROL METHOD

(71) Applicant: Akio Ando, Osaka (JP)

(72) Inventor: Akio Ando, Osaka (JP)

(73) Assignee: KYOCERA CORPORATION, Kyoto (JP)

(21) Appl. No.: 13/612,022

(22) Filed: Sep. 12, 2012

(30) Foreign Application Priority Data
Sep. 27, 2011 (JP) 2011-211268

(51) Int. Cl. G06F 3/041

(52) U.S. Cl. 345/173

(57) ABSTRACT

A mobile terminal is provided that displays on a display, when a touch operation is detected on the display where a primary image including a plurality of display objects is displayed, a secondary image with multiple representative display objects that represent at least two display objects displayed within a predetermined range of a first touch position, the multiple representative display objects arranged around the first touch position. After the secondary image is displayed, one display object represented by one representative display object arranged on a second touch position is received as a target of processing, when the touch operation is detected to move from the first touch position to the second touch position.

### TECHNICAL FIELD

The present invention relates to portable terminals with displays such as mobile phone devices, and in particular to the improvement of user interfaces.

### BACKGROUND ART

When a user wishes to select from a display, by touch operation, a single display object from a plurality of display objects with a relatively small display size such as icons, buttons, and keys, the user may inadvertently select a different display object from the desired display object. This is because when a user tries to select their desired display object, they may inadvertently touch with a fingertip, etc, on a display object that is different to the one which they intended to touch, due to the small size of the display objects.

Regarding this issue, the technology of Patent Literature 1 is known.

With the technology of Patent Literature 1, a display with a touchpad of a portable terminal may display an icon of a keyboard which is so small that its individual keys are not identifiable. When touching with a fingertip, etc, a certain area of that icon, the keys which make up the area that was touched will be expanded. A user will thus be able to select the desired key from among the expanded and now identifiable keys.

### CITATION LIST

### Patent Literature

### Patent Literature 1

Japanese Patent Application Publication No. 2002-505783

### SUMMARY OF INVENTION

### Technical Problem

However, with the technology of Patent Literature 1, the keys displayed are included in a part, corresponding to a touch position on the icon, which is too small to allow for identification of the individual keys.

Accordingly, if a user fails to correctly touch with a fingertip, etc, the area corresponding to a part where the desired key is located, then the desired key will not be among those displayed, and thus a user will be unable to select the desired key.

In this situation, in order to display the desired key, a user will, for example, have to delete the key display to once again display the keyboard icon, and once again touch with a fingertip, etc, an area of the displayed icon which should include the desired key. This makes selecting a desired key take longer.

The present invention has been conceived in light of this issue, and aims to provide a new user interface for rapid selection of a single display object even when a plurality of display objects on a portable terminal have a comparatively small display size.

### Solution to Problem

A mobile terminal that receives as a target of processing, one display object selected by a touch operation from a plurality of display objects, the mobile terminal comprising: a display that shows a primary image including the plurality of display objects; a detection unit that detects the touch operation on the display; a display control unit that displays, on the display, a secondary image including at least two representative display objects, that respectively represent display objects displayed in a predetermined range of a first touch position where the touch operation has been performed, and that are arranged around the first touch position, and a reception unit that, when a moving touch operation is detected to move from the first touch position to a second touch position after the secondary image has been displayed, identifies one representative display object located on the second touch position, and receives as the target of processing, one display object represented by the one representative display object.

### ADVANTAGEOUS EFFECTS OF INVENTION

With the portable terminal of the present invention including the above structure, rapid selection of a single display object is possible even when a plurality of display objects have a comparatively small display size.

### BRIEF DESCRIPTION OF DRAWINGS

FIG. 1 is a front view diagram showing the exterior of a mobile phone device 100 of the embodiment.

FIG. 2 shows a display example of a secondary image G20A that appears when a user performs a long press on a “D” key area of a SW keyboard G11.

FIG. 3 shows a user selecting an “R” key which the representative Ksr key on the secondary image G20A shows.

FIG. 4 shows a display example of the letter “r” corresponding to the “R” key selected by the user.

FIG. 5 shows a display example of a secondary image G20B that appears when a user performs a long press on an “A” key area of the SW keyboard G11.

FIG. 6 is a block diagram showing the function structure of the main part of the mobile phone device 100.

FIG. 7 shows a data structure and content example of a key information table 10.

FIG. 8 shows the display areas in the secondary image G20 which displays area information from A0 to A6.

FIG. 9 is a flowchart showing the control process of the mobile phone device 100.

FIG. 10 shows a display example of the secondary image G20C that appears when a user performs a long press on an “A” key of the SW keyboard G11 of the mobile phone device 200 of the modifications.

### DESCRIPTION OF EMBODIMENTS

The following describes a mobile phone device as an embodiment of a mobile terminal according to the present invention.

### Embodiment 1

### 1. User Interface Specification

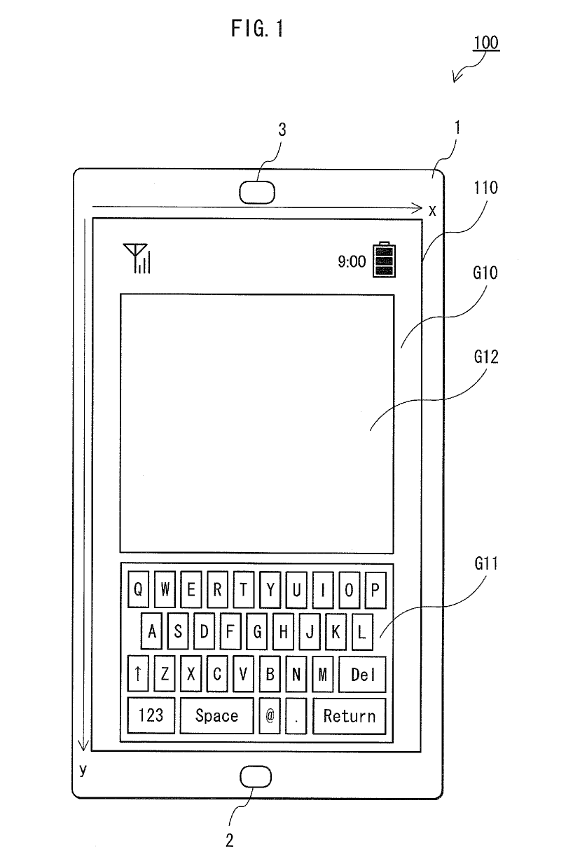

FIG. 1 is a front view diagram showing the exterior of a mobile phone device 100 of the embodiment.

As shown in the diagram, the mobile phone device 100 is a straight-type terminal including a main casing 1, a microphone 2, a receiver 3 and a display 110.

The diagram shows a display example of a primary image G10 which includes on the display 110 a software keyboard G11 (hereafter, SW keyboard) and an input location G12 for displaying characters corresponding to keys selected by a user.

Note that, in the embodiment, a touchpad 112 is used to detect touch operations of the display 110 as described below. When a user touches the touchpad 112 with a fingertip, etc, continuously for a length of time which is equal to or exceeds a predetermined time, this is known as a “long press”. When a user touches the touchpad 112 with a fingertip, etc, for a length of time which is less than the predetermined length of time, this is known as a “short press”.

Also, in the embodiment, keys which form the SW keyboard G11 will be used in the explanation as one example of display objects, and the selection of keys will be described by a user touching with a fingertip, etc, on the display position of the keys.

Here, when a user attempts to select a key by touching the display area of the key with a fingertip, it is possible that a user may accidentally press a key adjacent to the desired key, due to the comparatively small display size of the keys which form the SW keyboard G11.

When a user performs a long press, the mobile phone device 100 displays the secondary image G20 on the display 110 so that the center of the secondary image G20 and the area where the long press operation was performed (hereafter, the first touch position) correspond, and in such a way that a part of the primary image G10 is hidden.

Here, the secondary image G20 has representative keys which show the individual keys within a predetermined range of the first touch position, arranged approximately in a circle with the first touch position as the center.

In the explanation of the embodiment, each representative key serving as an example of each representative display object, represents a key displayed by the first touch position and the other keys placed adjacent to that key, with the representative keys expanding the display size of the keys they represent.

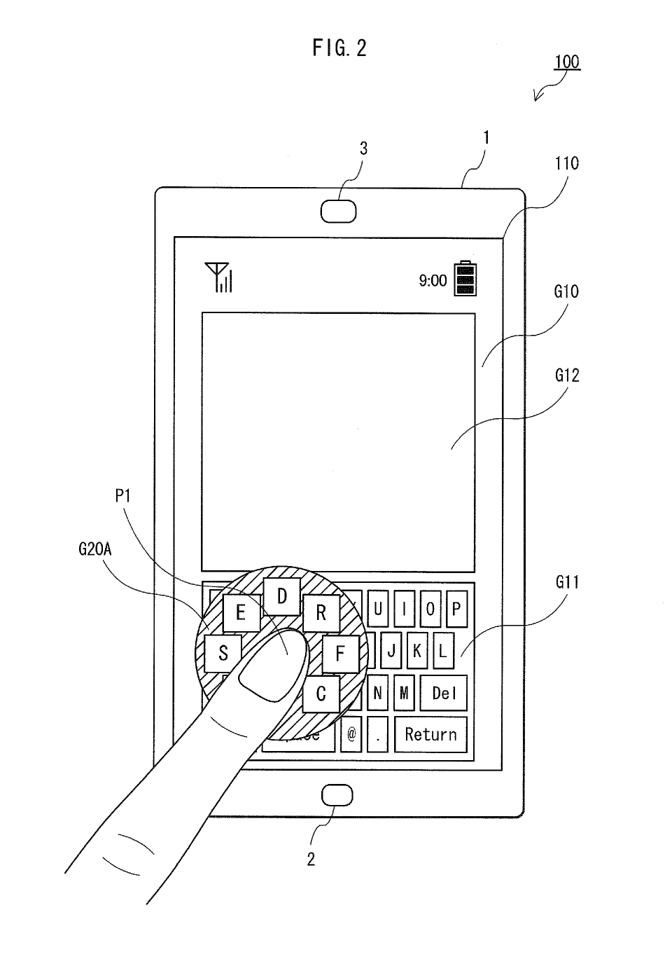

FIG. 2 shows a display example of the secondary image G20A in a situation where a user has performed a long press on the “D” key display area of the SW keyboard G11.

In this example, the mobile phone device 100 has displayed the secondary image G20A on the display 110, wherein the keys representative of the “D” key and the six other keys adjacent to the “D” key which is displayed at the touch position P1 which is the area where a long press has been performed, are arranged approximately in a circle with the first touch position P1 as the center. In other words, the representative keys positioned on the secondary image G20A are positioned on areas approximately equidistant from the first touch position P1.

As shown in FIG. 1, the six keys which are adjacent to the “D” key are the “R” key, the “F” key, the “C” key, the “X” key, the “S” key and the “E” key. As shown in FIG. 2, the display size of the representative keys which represent these six keys has been expanded from that of the six keys shown in FIG. 1. Due to this, a user is able to accurately select with a fingertip, etc, their desired key that is represented by one of the representative keys, from among the representative keys shown.

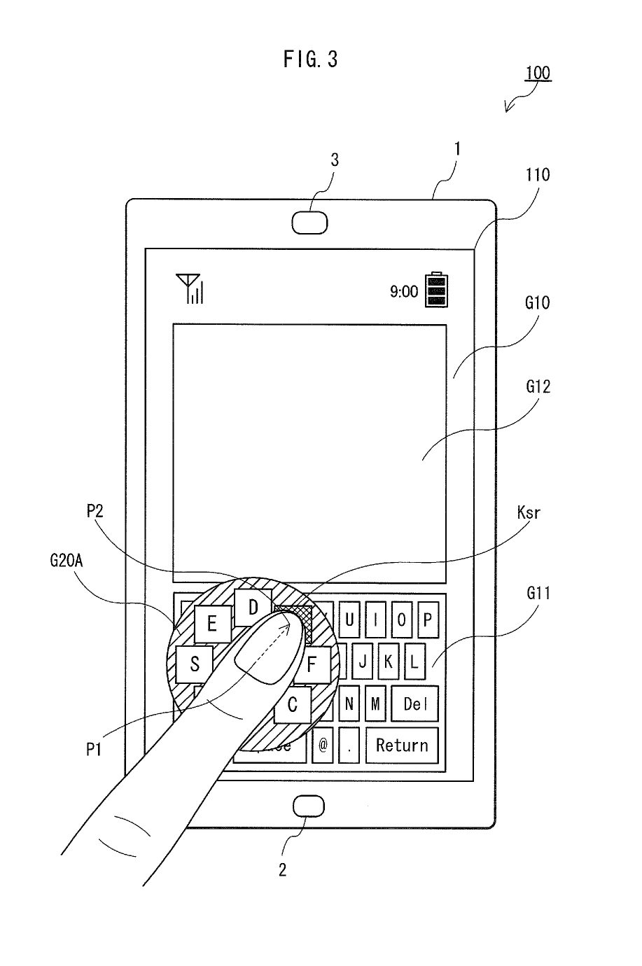

For example, as shown in FIG. 2, a user moves the position of their fingertip which was touching the first touch position P1, in other words the approximate center of the circle of the secondary image G20A, away from the first touch position P1 to the second touch position P2 shown in FIG. 3, then releasing the touch (known as a drag operation).

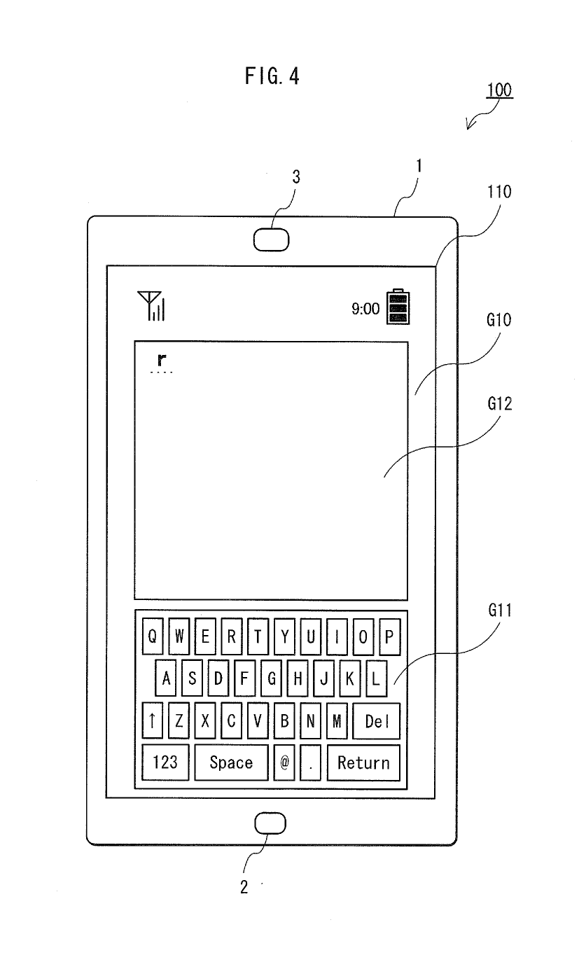

Upon doing so, the mobile phone device 100 receives the “R” key represented by the representative Ksr key displayed on the second touch position P2, and thus, as shown in FIG. 4, a letter “r” corresponding to the “R” key touched by the user is displayed in the input area G12.

As described above, seven representative keys are positioned circumferentially on the secondary image G20A with the first touch position P1 as the center, as shown in FIG. 2. Accordingly, with the selection by a user of the Ksr key that represents the “R” key shown in the example of FIG. 3 serving as just one example, whichever of the seven keys represented by the corresponding seven representative keys may be selected with an equal dragging distance of a user's fingertip, etc.

In other words, with the mobile phone device 100, the operation input is the same whenever a user selects a single key represented by a representative key from among the representative keys available, making operations smooth.

Note that the shape of the secondary image G20 does not have to be a circular shape as shown in FIGS. 2 and 3. It may also be a fan shape, depending on its position (the first touch position) on the display 110 when a user makes a long press operation.

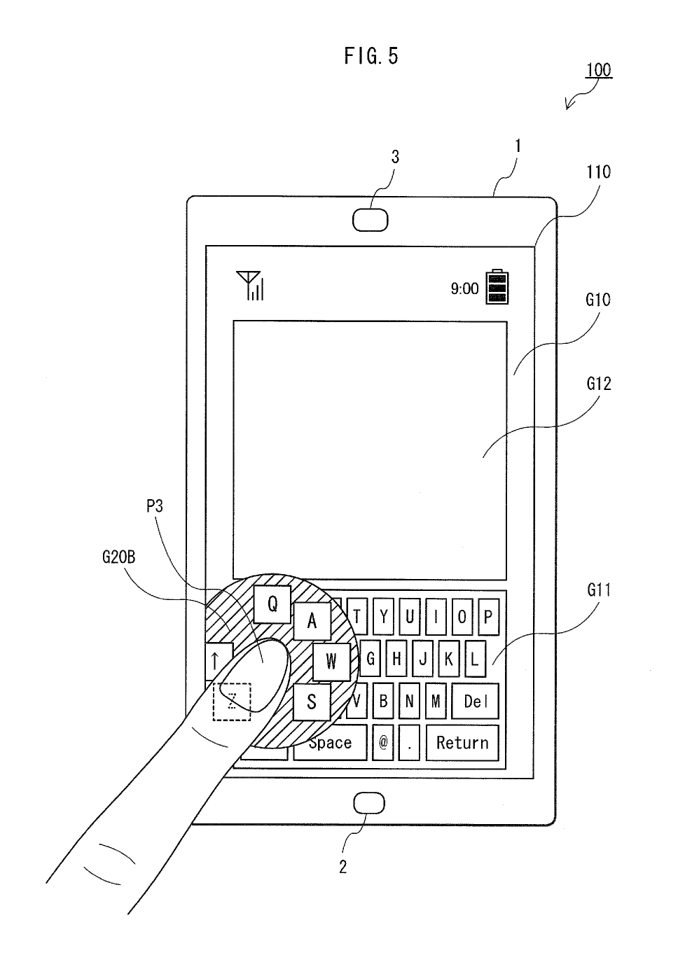

FIG. 5 shows a display example of the secondary image G20B in a situation where a user has performed a long press on the “A” key display area of the SW keyboard G11.

In this example, the mobile phone device 100 has displayed the secondary image G20B on the display 110, wherein the keys representative of the “A” key and the five other keys adjacent to the “A” key which are shown on the touch position P3 are arranged approximately in a circle with the first touch position P3 as the center. The secondary image G20B has a fan shape due to the relationship between the display area of the display 110 and the first touch position P3.

### 2. Structure of Functions

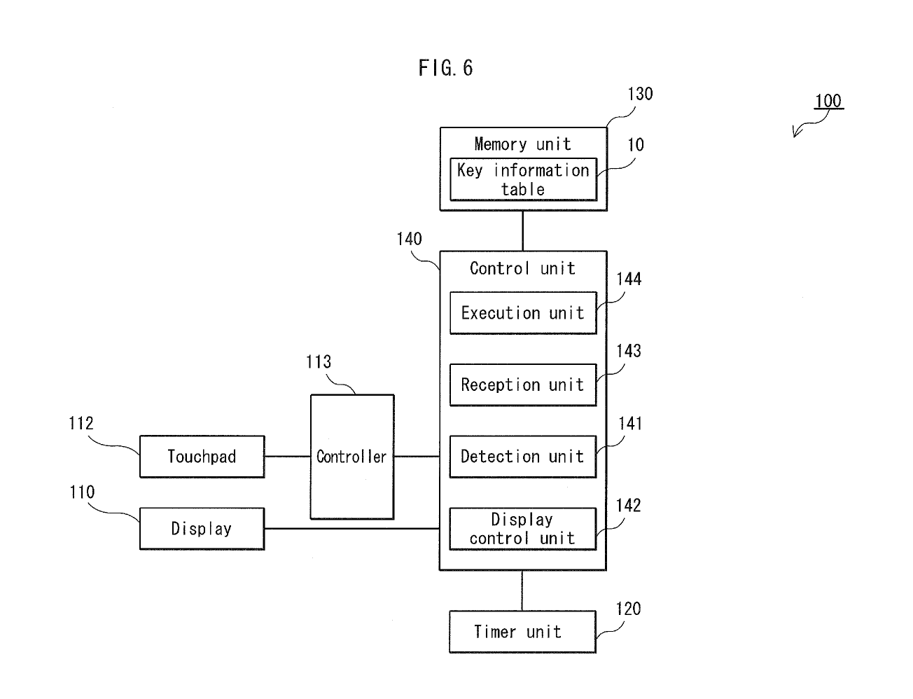

The following is an explanation of the function structure of the mobile phone device 100 using FIG. 6.

FIG. 6 is a block diagram showing the function structure of the essential parts of the mobile phone device 100.

The mobile phone device 100 includes a display 110, a touchpad 112, a controller 113, a timing unit 120, a memory unit 130 and a control unit 140, as shown in FIG. 6.

Note that in FIG. 6, drawings of the mobile phone device including the microphone 2, receiver 3 and the general communication units as shown in FIG. 1, are not included. Also, the mobile phone device 100 includes a processor and memory in its structure, and the functions of the control unit 140 are implemented by the processor running programs stored in the memory.

Here, the display 110 includes an LCD (Liquid Crystal Display), which receives instructions from the control unit 140 to display various images, with the number of pixels (the vertical and horizontal alignments of FIG. 1) being, for one example, 480 pixels by 800 pixels.

The touchpad 112 is a capacitance method touch sensor superimposed on the LCD of the display 110. The touchpad 112 is structured using transparent materials, so that images displayed on the LCD of the display 110 may be viewed.

Further, the controller 113 is an IC (Integrated Circuit) that detects the touch of a user's fingertip, etc, on the touch pad 112, and every so often while the touch has been detected (for example, every 25 ms), outputs the coordinate values (x, y) of the touch position of the touch pad 112 to the control unit 140.

In FIG. 1, the coordinate value of the top left edge of the display 110 is (0, 0), and the coordinate of the bottom right edge is (479, 799).

Also, the timer unit 120 is actualized by a timer or counter, beginning to time at the instruction of the control unit 140. Upon the elapsing of a predetermined time (for example, three seconds) used to determine whether or not a long press operation has been performed, the timer unit 120 notifies the control unit 140. Note that the predetermined time is set in advance by the manufacturer, etc, of the mobile phone device 100.

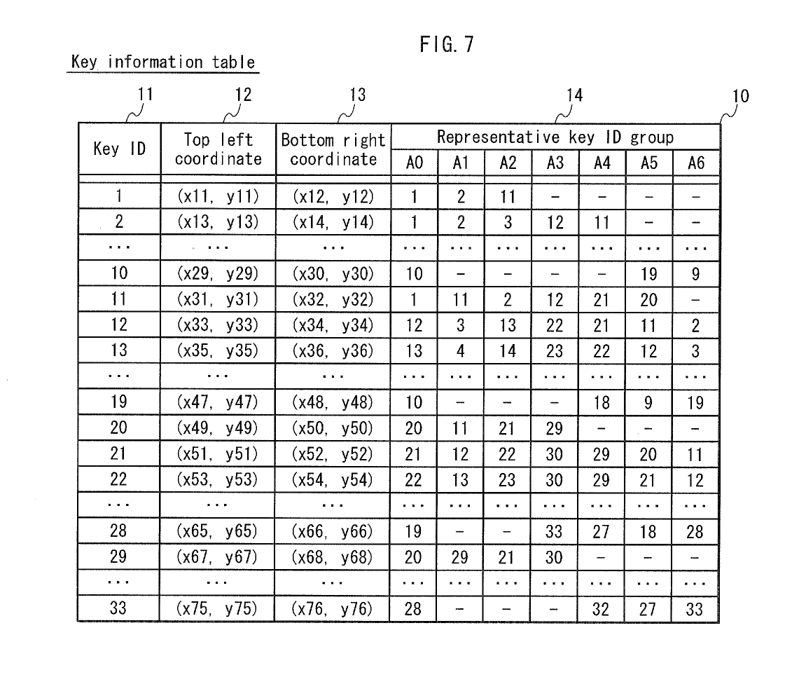

Also, the memory unit 130 is a memory area for recording the key information table 10 (refer to FIG. 7). The key information table 10 stores the positions of the keys which form the SW keyboard G11 and the adjacent keys of each key. The data structure, etc, of the key information table 10 will be discussed later.

The control unit 140 has in particular, among other functions held by regular mobile phone devices, a function to receive character input from keys selected by a user from among keys which form the SW keyboard G11 shown in the display 110. The control unit 140 includes a detection unit 141, a display control unit 142, a reception unit 143 and an execution unit 144.

Here, the detection unit 141 has a function to detect touch operation of the touchpad 112 (a short press or a long press), based on the reception of coordinate values from the controller 113. The detection unit 141 determines whether the touch operation is a short press or a long press by beginning timing of the predetermined time with the timer unit 120 upon commencement of the touch.

Also, the display control unit 142 has a function to control the display of the display 110, in particular, making the display 110 display the secondary image G20 when the detection unit 141 detects a long press and a key is displayed in the first touch position where the long press operation was performed. Note that the display control unit 142 ends display of the secondary image G20 to display on the display 110 a screen according to the processing results of the execution unit 144, once a key is selected that is represented by one representative key among representative keys located on the secondary image G20 of the display 110.

Also, the reception unit 143 has a function to receive, as the target of processing, a key represented by a representative key, from among the representative keys of the secondary image G20, that is displayed on a location of the display (the second touch position) of the touchpad 112 where the touch is released.

Also, the execution unit 144 has a function to perform the corresponding processing of the key received by the reception unit 143 as the target of processing. Also, the execution unit 144 has a function to perform the corresponding processing of the key displayed in a touch position when the detection unit 141 detects a short press operation. In the embodiment, one example of the corresponding processing of the key might be the inputting of a character corresponding to the key, and the displaying of the character, with the display control unit 142, in the input area G12 of the display 110.

### 3. Data

The following is an explanation of the data used by the mobile phone device 100, with reference to FIG. 7.

FIG. 7 shows the data structure and content example of the key information table 10.

The key information table 10, as shown in FIG. 7, is a table of information associating a key ID 11, a upper left coordinate 12, a lower right coordinate 13 and a representative key ID group 14 for each of the keys which make up the SW keyboard G11.

Here, the key IDs 11 are identification information for keys, and in this example, use numerals which increase one by one from the number one, in the placement order of the keys of the SW keyboard G11. That is to say, as shown in FIG. 1, the key ID of the “Q” key located at the top left is “1” and the key ID of the “P” key located at the rightmost end of the same line is “10”. The key ID of the “A” key located at the leftmost edge of the next line is “11”, and the key ID of the “Return” key located at the bottom right is “33”.

When a user is holding the mobile phone device 100 so that the characters of keys represented by the corresponding key IDs are recognizable as those characters by the user, then the upper left coordinate 12 and the lower right coordinate 13 will be the upper left and lower right corners of the scope of those keys (the rectangle area). Note that x11 to x76 and y11 to y76, as shown in FIG. 7, show specific coordinates.

Also, when a long press operation is performed on the key display area of the key corresponding to the key ID, the representative key ID group 14 are the key IDs of the keys represented by the representative keys that should be located on the secondary image G20, in other words, the keys represented by the corresponding key IDs and the key IDs of the keys adjacent to those keys, and are registered as position information A0 through A6.

Here, the position information A0 to A6 show display areas where the representative keys should be displayed on the secondary image G20.

In FIG. 7, for example, the upper left coordinate value of the key whose key ID is “1” (in other words, the “Q” key) is x11, y11, and the lower right coordinate value is x12, y12. The representative key group shows the representative keys which represent the “1”, “2”, and “11” keys (in other words, the “Q” key, the “W” key and the “A” key) in the A0, A1 and A2 position information which show the location within the secondary image G20.

The following is an explanation of the relationship between the A0 through A6 position information and the display positions within the secondary image G20.

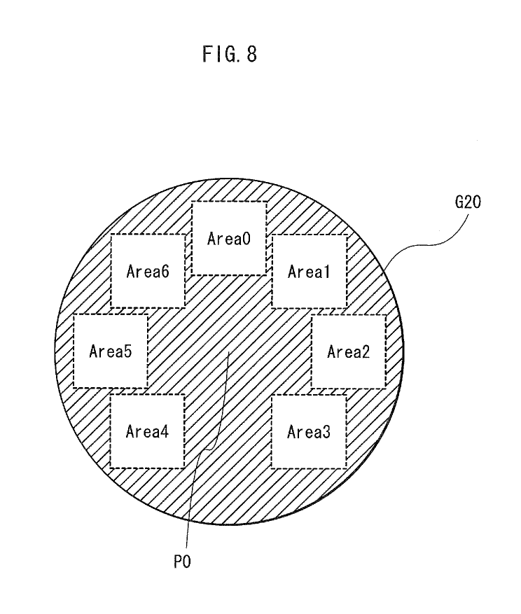

FIG. 8 shows an explanation of the display areas within the secondary image G20, that are shown by the position information A0 through A6.

As shown in FIG. 8, Areas 0 through 6 are rectangular areas which show representative keys provided inside the circumference of the circle shaped secondary image G20. Areas 0 through 6 represent the display positions shown by position information A0 through A6.

Note that the coordinate values of Areas 0 through 6 (for example, with the middle of the circle being the origin point of the relative coordinate values), are already stored in the memory, and the display control unit 142 performs display of the secondary image G20 based on these coordinate values.

As shown in FIG. 8, Area 0, Area 1 and Area 6 are located in a position of an upper part above the central P0, in other words, the first touch position of the secondary image G20, and Area 3 and Area 4 are located in a position of a lower part below the first touch position.

Here, as shown in FIG. 2, when a user is holding the mobile phone device 100 so that the characters of the representative keys arranged on the secondary image (G20A) are recognizable as those characters by the user, the upper side of the screen will be the “upper part” and the lower side of the screen will be the “lower part”

Note that, as shown in FIG. 8, Area 2 and Area 5 are in positions that are on approximately the same level vertically, as the first touch position.

In the representative ID group corresponding to the key ID “1” of FIG. 7, the key ID “1” corresponding to area information A0, the key ID “2” corresponding to area information A1, and the key ID “11” corresponding to area information A2 are registered thusly. Accordingly, when a long press operation is performed on the display area of the “Q” key which has a key ID of “1”, the representative keys for the “Q” key, “W” key and “A” key are displayed in Area 0, Area 1, and Area 2 of the secondary image G20. Note that in this case, the other areas of the secondary image G20 (Areas 3-6) will have no representative keys displayed therein.

Here, the representative key which represents the “Q” key shown in the area where the long press operation was performed (the first touch position) is placed in the upper part above the first touch position. This is because the “Q” key displayed in the first touch position by the performing of the long press operation is generally considered to be highly likely to be chosen by a user. Therefore, by placing the representative key for the “Q” key in an upper part above the first touch position, it is less likely that the key will be obscured by the user's hand and thus be difficult to find.

The “Q” key placement above is just one example. So that the representative keys representing the keys displayed on the position of the long press operation (the first touch position) are displayed above the first touch position, for each key ID, the key ID that is the same as the representative key that represents the key displayed on the first touch position is registered to correspond with one of the representative key ID group information A0, A1 or A6, with the key information table 10 example shown in FIG. 7.

Also, in the example of the key information table 10 shown in FIG. 7, the representative keys which represent the keys displayed in the first touch position and the adjacent keys, are positioned in a clockwise formation in the order of the size of the angle between the central position of the keys represented by the representative keys, and the polar coordinate of the first touch position that is the pole. This is to arrange the representative keys which represent the keys adjacent to the key displayed in the first touch position, on the secondary G20, in order to preserve as far as possible the relative position of those keys corresponding to the first touch position on the SW keyboard G11. In other words, by placing the representative keys in this way, it will be easy for a user to grasp the location of the representative keys representing the keys, likely to be selected, which are adjacent to the key displayed in the first touch position.

For example, for the representative keys which represent the “W” and “A” keys which are adjacent to the “Q” key, the representative key representing the “W” key is placed in Area 1, and the representative key representing the “A” key is placed in Area 2. In other words, they are positioned in a clockwise formation in the order of the size of the angle between the central position of the “W” key or “A” key respectively, and the polar coordinate of the first touch position that is the pole.

### 4. Operations

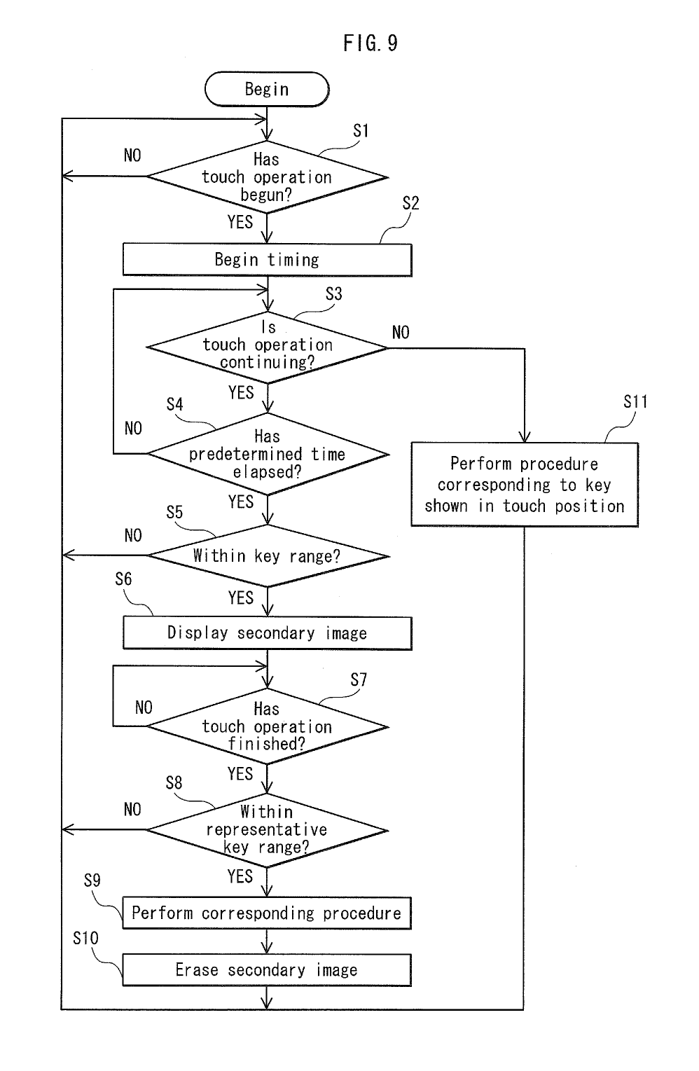

The following is an explanation using FIG. 9 of the operations of the mobile phone device 100, including the above structure, which handles the above data.

FIG. 9 is a flowchart showing the control process of the mobile phone device 100.

The control process shown in FIG. 9 is initiated when the mobile phone device 100 is switched ON, and, although not shown in the diagram, finishes when the phone is turned OFF.

First, the detection unit 141 of the mobile phone device 100 determines whether or not a user has begun touch operation on the touchpad 112, based upon whether or not coordinate values are received from the controller 113 (Step S1).

When no coordinate values are received from the controller 113, the detection unit 141 determines that a user has not begun touch operation on the touchpad 112 (“No” in Step S1), in which case the process of Step S1 is repeated.

Also, when the detection unit 141 has received coordinate values from the controller 113, the detection unit 141 determines that a user has begun touch operation on the touchpad 112 (“Yes” in Step S1), and makes the timer unit 120 being timing for a predetermined length of time (Step S2). This is to determine whether or not the touch operation initiated in Step S1 is a long press operation.

Next, the detection unit 141 determines, based on whether or not coordinate values have been received from the controller 113, whether or not the touch operation initiated in Step S1 has continued (Step S3).

When the detection unit 141 receives coordinate values from the controller 113, the detection unit decides that the touch operation is continuing (“Yes” in Step S3) and, based on the presence or lack of notification from the timer unit 120, determines whether or not the predetermined time has elapsed (Step S4).

When the detection unit 141 has not received any notification from the timer unit 120, the detection unit decides that the predetermined time has not elapsed (“No” in Step S4), in which case the process is repeated from Step S3.

Also, when the detection unit 141 has received notification from the time unit 120, the detection unit 141 decides that the predetermined time has elapsed (“Yes” in Step S4). The detection unit 141 then stores the last coordinate values received from the controller 113 into an area in the memory (hereafter, the first area). This is in order to transmit the coordinate values which show the first touch position to the display control unit 142, since the touch operation begun in Step S1 is a long press.

The display control unit 142 determines, based on the key information table 10, whether or not the coordinate values stored in the first area are included in the scope of the keys which form the SW keyboard G11 (Step S5). In other words, when coordinate values stored in the first area are included in the (rectangular) scope of one of the keys identified by the upper left coordinate value or lower right coordinate value registered in the key information table 10, then the display control unit 142 determines that the coordinate value stored in the first area is included in the scope of one of the keys (“Yes” in Step S5).

When the display control unit 142 determines that the coordinate value stored in the first area is not included in the scope of one of the keys (“No” in Step S5), then this means that the long press was performed outside of the display area of the keys which make up the SW keyboard G11. In this case, the detection unit 141 repeats the process from Step S1 again, without the secondary image G20 being displayed (Step S6).

Also, when the display control unit 142 determines that the coordinate value stored in the first area is included in the scope of one of the keys (“Yes” in Step S5), then this means that the long press was performed in the display area of the keys which make up the SW keyboard G11. In this case, the display control unit 142 displays the secondary image G20 on the display 110 (Step S6).

In other words, the display control unit 142 acquires the representative keys, for the key which the coordinate value stored in the first area has been determined to be within the scope of, shown by the key information group registered in the key information table 10. Then, the display control unit 142 displays the secondary image G20, the secondary image G20 having arranged thereon the acquired representative keys in positions shown by the corresponding area information, with the coordinates stored in the first area as the central point, and so as to obscure a part of the primary image.

Also, for the acquired representative key IDs, the display control unit 142 stores, in an area on the memory (hereafter, the representative key area) the upper left and lower right coordinate values of the rectangular area where the representative keys are located. The coordinate values stored in the representative key area are used in the determination made in Step S8 which will follow. Note that the upper left and lower right coordinate values of the rectangular area where the representative keys are located are calculated by the display control unit 142 based on the relative coordinate values of the Areas 0-6 already stored in memory (relative coordinate values taking the center of the circle as the origin point) so as to show the coordinate values stored in the first area (first touch position) as the origin point value.

Next, the detection unit 141 determines whether or not the touch operation initiated in Step S1 has finished, based upon the reception or lack of reception of coordinate values from the controller 113 (Step S7).

When the detection unit 141 has received coordinate values from the controller 113, the detection unit 141 decides that the touch operation is continuing (“No” in Step S7), in which case the process of Step S7 is repeated again.

Also, when the detection unit 141 has not received coordinate values from the controller 113, the detection unit 141 decides that the touch operation has finished (“Yes” in Step S7). In which case the detection unit 141 stores the last received coordinate value from the controller 113 in an area on the memory (hereafter, the second area). This is in order to transfer the coordinate values which show the second touch position to the reception unit 143, since the long press operation begun in Step S1 has finished.

The reception unit 143 determines whether or not the coordinate values stored in the second area are included in the range of one of the representative keys shown within the secondary image G20 (Step S8).

In other words, the reception unit 143 determines that the coordinate values stored in the second area are included in the range of one of the representative keys when the coordinate values stored in the second area are included in the (rectangular) scope of one of the representative keys identified with the upper left coordinate and lower right coordinate values stored in the representative key area (“Yes” in Step S8).

When the reception unit 143 determines that the coordinate values stored in the second area are not included in the (rectangular) scope of one of the representative keys shown within the secondary image G20 (“No” in Step S8), then this means that the user's fingertip, etc, has moved elsewhere from the display position of the representative keys located in the secondary image G20. Accordingly, the detection unit 141 repeats the process from Step S1 again, without performing the process corresponding to the key (Step S9) which will be described below.

Also, when the reception unit 143 determines that the coordinate values stored in the second area are included in the (rectangular) scope of one of the representative keys shown within the secondary image G20 (“Yes”, in Step S8), then the reception unit 143 transfers the key ID of the key represented by the representative key and determined to be included in the representative key scope to the execution unit 144 using the memory.

The execution unit 144 performs the process corresponding to the key shown by the transferred key ID (Step S9). In other words, in this example, the execution unit 144 receives input of the character corresponding to the key, and displays the character on the input area G12 of the display 110 via the display control unit 142.

To continue, the display control unit 142 erases the secondary image G20 made to be displayed by Step S6 (Step S10), and the detection unit 141 repeats the process from Step S1. Note that the erasing of the display of the secondary image G20 means, for example, going from a state where the secondary image G20A is being displayed, as shown in FIG. 3, to a state where the secondary image G20A is not being displayed, as shown in FIG. 4.

Alternatively, in Step S3, when the detection unit 141 does not receive coordinate values from the controller 113, the detection unit 141 decides that the touch operation has finished (“No” in Step S7). In which case the detection unit 141 stores the last coordinate value received from the controller 113 in the first area. Since the touch operation begun in Step S1 is a short press, this is in order to transfer the coordinate values which show the area where the short press operation was performed to the execution unit 144.

The execution unit 144 identifies, based on the key information table 10, one of the keys which form the SW keyboard G11 and is included in the scope of the coordinate values stored in the first area. The execution unit 144 then performs the process corresponding to the identified key (Step S11). The detection unit 141 then repeats the process from Step S1. Note that when the coordinate values stored in the first area are not included in the scope of one of the keys which form the SW keyboard G11, then the execution unit 141 repeats the process from Step S1.

### [Modifications]

The above section has been an explanation of the mobile phone device of the embodiment of the present invention, however the following modifications are also possible. The invention is not limited to the mobile phone device shown in the embodiment.

(1) In the embodiment, the display object that is the target of processing has been explained to be a key on the SW keyboard, but may also be another display object such as an icon or button instead of a key.

Also, the previously explained key type, order and location on the SW keyboard is just one example. Suitable modifications are possible, for example, having each key placed on a grid.

(2) It has been explained that when a long press operation is performed with the mobile phone device 100 relating to the embodiment of the above section, the secondary image G20 is displayed. However, the secondary image G20 may be made to be displayed following other touch operations (such as a drag operation) on the touchpad 112. Note that, in this case, the secondary image G20 is displayed with the start position or finish position of the drag being the first touch position.

Also, with the mobile phone device 100 of the embodiment, it has previously been explained that when a short press operation is performed, the corresponding process is performed for the key displayed in the location the short press operation was performed on, without displaying the second image G20. However, the second image G20 may be displayed regardless of the kind of touch operation (short press, long press). In this case, the steps S2 to S4 and S11 of the flowchart shown in FIG. 9 are not performed. In other words, when a touch operation initiation has been detected in Step S1 (“Yes”), it is possible to proceed to Step S5.

Additionally, in the embodiment, it was explained that the predetermined time frame used to detect a long press or absence of a long press is determined in advance by the manufacturer of the mobile phone device 100. However, a user may determine this setting instead.

(3) In the embodiment, it was explained that the secondary image G20 is displayed when a long press operation is performed on the display position of one of the keys which make up the SW keyboard G11. Multiple representative keys which represent both the key displayed in the location where the long press was performed and all of the keys which surround that key, are arranged on the secondary image G20.

However, the secondary image G20 may be made to be displayed only when a long press is performed on the display location of a specific class of key (for example, only alphabetical keys). Also, it is possible that, of the representative keys which represent both the key displayed in the location where the long press was performed and all of the keys which surround that key, only those keys belonging to the specific classification may be arranged on the secondary image G20. For example, it is possible for the secondary image G20 not to be displayed when a long press is performed on the display location of the “Spacebar” key, and when a long press is performed on the location of the “C” key, then it is possible for a representative key representing the “Spacebar” key not to be arranged on the secondary image G20.

Note that, in this modification, the class of key which initiates displaying of the secondary image G20 when a long press operation is formed and the class of the keys represented by the representative keys that are arranged on the secondary image G20 are the same. However, they may be of different classifications as well. Also, the key which initiates displaying of the secondary image G20 when a long press operation is formed and the keys represented by the representative keys that are arranged on the secondary image G20 may be defined individually by key.

Also, it is possible to exclude those keys that have a display size that is larger than the normal key size (i.e, the “Del” key, “123” key, “Spacebar” key, and “Return” key, in FIG. 1) from the aforementioned identified key classification. This is because it is conceivable that a user would be able to select such larger than normal keys with a regular touch operation without having to deliberately bring up the secondary image G20.

Additionally, in the embodiments, an SW keyboard G11 made up of non-uniform size keys was used as an example, but uniformly sized keys may be utilized as well.

As well, in the embodiments, an example was explained wherein the multiple representative keys have been enlarged from the multiple keys they represent, but they may be the same size.

(4) In the embodiment, it was explained that the secondary image G20 is a circular shape, but it may be rectangular or another shape. Also, even when changing the shape of the secondary image G20 to a different shape, the multiple representative keys may still be arranged on an approximate circle with the first touch position in the center of the circle, or may be arranged to fit the shape of the secondary image G20, in other words, arranged on the internal circumference of the secondary image G20.

Also, in the embodiment, it was explained as shown in FIG. 8 that the multiple representative keys are arranged on the locations of Areas 0 through 6, but this is just one example, and arrangement of the multiple representative keys on other locations is also possible.

As well, in the embodiment, a method was explained that utilizes the key information table 10 as one way to identify keys represented by the multiple representative keys arranged on the secondary image G20, in other words, keys displayed within a predetermined range of the first touch position. That is, in the embodiment, an example was explained for identifying the key displayed on the first touch position and the keys surrounding that key by registering the representative key ID group 14 in the key information table 10 in advance.

However, it is also possible to, for example, identify the keys displayed in the predetermined range of the first touch position based not on the representative key ID group 14 but on the upper left coordinate 12 and lower right coordinate 13 registered in the key information table 10. With this modification, the representative key ID group 14 does not need to be registered.

In more detail, the following example is conceivable. The coordinate of the middle point of each key is calculated based on the upper left coordinate 12 and lower right coordinate 13, or alternatively, calculated in advance and registered in the key information table 10. The keys that have a distance from their middle point to the first touch position that is within the predetermined range are identified to be keys which exist within the predetermined range of the first touch position.

(5) It has been explained that the mobile phone device 100 pertaining to embodiment 1 has multiple representative keys arranged on the secondary image G20 on an approximate circle with the first touch position as the center of the circle.

However, the multiple representative keys do not necessarily have to be placed in locations equidistant from the first touch position in this way. The multiple representative keys may be placed around the circumference of the first touch position. For example, representative keys which represent keys more likely to be selected by a user, such as the key displayed on the first touch position, may be placed on a location that is even closer to the first touch position.

Also, with the mobile phone device 100 of the embodiment, it was explained that, by registering the representative key ID group 14 in the key information table 10 in advance, the representative keys which represent the adjacent keys are arranged on the approximate circle in increasing polar coordinate order with respect to the pole, which is the first touch position, and the angle to the center of each of the keys represented by the representative keys.

However, the placement of the multiple representative keys may be decided without using the representative key ID group 14. For example, the coordinate of the middle point of each key is calculated based on the upper left coordinate 12 and lower right coordinate 13, or alternatively, calculated in advance and registered in the key information table 10. Then, the angle of the polar coordinate of the center point of the key (with the first touch position as the pole) is calculated for each key adjacent to the key displayed in the first touch position. The keys may then be arranged on an approximate circle in order of angle size in clockwise formation with the first touch position as the center of the circle.

As an example, let the coordinates of the key adjacent to the key displayed in the first touch position be (x1, y1), and let the coordinates of the first touch position be (x0, y0). Let x1−x0 be dx and let y1−y0 be dy. In this case, the angle θ can be shown with formula 1.

θ=Tan⁻¹(dy/dx)−π/2(|dx|/dx−1) (Formula 1)

However, when dy is negative in a case where dx is 0, then θ is 3π/2. When dy is positive in a case where dx is 0, then θ is π/2. Note that for formula 1, |dx| shows the absolute value of dx.

Also, the arranging of the multiple representative keys which represent the keys adjacent to the key displayed in the first touch position may be achieved not only by order of the angle of polar coordinates as above, but may also be arranged arbitrarily, for example, in alphabetical order.

As well, in the embodiment, it was explained that the representative key that represents the key displayed on the first touch position should be placed in a location on the secondary image G20 that is above the first touch position. However, another option may place the representative key on the same level as the first touch position or alternatively, below it.

Also, the representative key that represents the key shown on the first touch position may especially be arranged on Area 0 of the possible locations above the first touch position. In this case, for each key ID, the key ID that is the same as the representative key that represents the key displayed on the first touch position is registered to correspond with the representative key ID group information A0, in the key information table 10.

As well, in the embodiment, the explanation used an example where the shape of the secondary image G20 is a fan shape according to the position of the secondary image G20 on the display 110 where the long press operation was performed, and one of the representative keys that represents the “↑” key is only partially shown on the secondary image G20B as shown in FIG. 5.

However, the multiple representative keys may be arranged so that the entirety of each of the multiple representative keys arranged on the secondary image G20 are displayed.

The following is an explanation of a mobile phone device 200 pertaining to a modification where the representative key which represents the key displayed in the first touch position is arranged on the Area 0, and moreover, where the entirety of each of the multiple representative keys are shown.

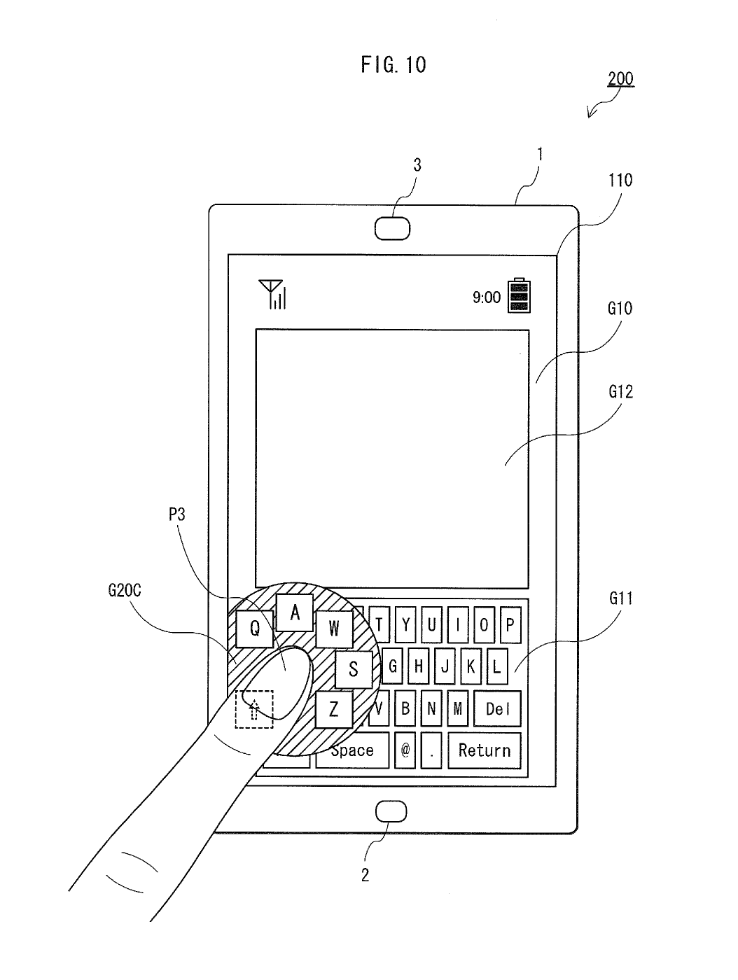

FIG. 10 is a display example of a secondary image G20C in a situation where a user has performed a long press operation on the display position of the “A” key of the SW keyboard G11 of the mobile phone device 200 of the modification.

In this example, the representative key representing the “A” key displayed in the location of a first touch position P3 is arranged on Area 0. The representative keys which represent the keys which are adjacent to the “A” key, namely, the “W” key, the “S” key, the “Z” key, the “↑” key and the “Q” key are arranged on Areas 1-4 and 6, and the representative keys are displayed in their entirety.

In order to achieve a display in this way, the representative ID group corresponding to the key ID “11” of the “A” key of the key information table 10 must be registered as follows. Namely; a key ID of “11” for position information A0; a key ID of “2” for position information A1; a key ID of “12” for position information A2; a key ID of “21” for position information A3; a key ID of “20” for position information A4; a key ID of “-” for position information A5; and a key ID of “1” for position information A6. Here, the registering of the key ID “-” for information position A5 is because when, for example, a user performs a long press operation on the display position of the “A” key, then arranging the representative key on Area 5 will result in the entirety of the representative key being unable to be displayed.

Note that the display example of the secondary image G20 of the mobile phone device 200 pertaining to the modification has been explained in the case of a long press operation being performed on the display position of the “A” key. However, to avoid the incidence of representative keys which are only partially displayed, then by registering representative key ID groups for each of the keys, other representative keys may be shown in their entirety in the same way.

(6) In the embodiment, as shown in FIG. 2, the upper edge of the screen was referred to as the “upper part” and the lower edge was referred to as the “lower part” when a user is holding the mobile phone device 100 so that characters represented by the multiple representative keys arranged on the secondary image (G20A) are recognizable as such by the user. In this way, the confirmation of the top and bottom alignment of the display remain the same even with a modification to rotate the screen depending on which way up the mobile phone device 100 is being held.

Namely, the side of the mobile phone device 100 of the embodiment with the receiver 3 is the upper part, and the side with the microphone 2 is the bottom part accordingly. With the mobile phone device of this modification, depending on which way up the screen is, the side with the receiver 2 may be either the upper part or the bottom part.

(7) In the embodiment, as shown in FIG. 9, it was explained that, when the touch position upon which a long press operation is performed is not included in the scope of one of the keys, (“No” in Step S5), then displaying of the secondary image G20 (Step S6) and the performing of the corresponding procedure (Step S9) are not performed. However, for example, if the touch position upon which a long press operation is performed is included in the scope of the display of the SW keyboard G11, then it is possible to interpret a touch position as having been performed on the location of one of the keys on the SW keyboard G11 which has the shortest distance between its own middle point and the position where the touch operation was actually performed.

In more detail, Step S5 is modified to determine whether or not a key is included in the display range of the SW keyboard G11, and if it is determined that a key is included in this range, then the center point of the key determined to have the shortest distance between its own middle point and the position where the touch operation was actually performed, is taken as the first touch position, and the procedure of step S6 may be performed. Note that, if it is determined that the key is not included in the display range of the SW keyboard G11, then the process may be repeated again from step S1.

(8) In the embodiment it was explained, as shown in FIG. 9, that after displaying the secondary image G20 and the touch operation has finished (“Yes” in Step S7), and when the last touch position (the second touch position) is not included in the scope of the representative keys (“No” in Step S8), then the corresponding procedure is not performed (Step S9).

However, if the final touch position is included in the scope of a key on display among the keys which form the SW keyboard G11, then the corresponding procedure may be performed. For example, with the situation shown in FIG. 2, when the touch position is moved (in other words, a drag operation), and the touch operation is released at the display position of, for example, the “K” key on the SW keyboard G11, then the procedure corresponding to the “K” key may be performed.

(9) The mobile phone device 100 of the embodiment was explained to be a straight-type terminal, but may be a mobile phone device with another appearance, such as a slide-type or folding-type, and may include another display as well as the display 110.

A mobile phone device including another display as well as the display 110 may display the SW keyboard G11 on the display 110 and display the input area G12 on the other display. Note that in this case, a touch pad to detect touch on the other display may be further included.

Also, in the embodiment, it was explained that the shape of the LCD of the display 110 is rectangular, but may be circular or another polygon form.

As well, in the embodiment, the number of pixels (vertical×horizontal) of the LCD of the display 110 was 480×800, however, the number of pixels is not limited to this number, and may be another suitable amount. Note that, in this case, the touchpad 12 should be made to be able to output coordinate values in keeping with the number of pixels on the LCD of the display 110.

In addition, it has been explained that the display 110 includes an LCD, but it may also include OEL (Organic Electro-Luminescence), etc.

As well, it was explained that the touchpad 112 of the mobile phone device 100 pertaining to the embodiment was actualized with an electrostatic capacitance style of touch sensor. This electrostatic capacitance style touch sensor may for example be a projection type with a pattern of a large number of electrodes formed on a substrate of plastic or glass, etc, which performs identification by measuring the ratio of amperage according to the pattern of the plurality of electrodes in the vicinity of the contact point. Alternatively, it may be a surface type structured with a conducting layer and substrate, with an electrode provided in a corner of the substrate, forming a uniform electric field according to amperage, which identifies a touch position by measuring the ratio of amperage of the corner electrode according to the touch of a fingertip, etc.

In addition, the touchpad 112 does not necessarily need to be actualized with an electrostatic capacitance style of touch sensor. Instead, (i) an electromagnetic induction type which uses a specialized pen such as an electronic pen, (ii) a matrix switch type formed of a 2 layer structure transparent electrode, (iii) a resistive film type which applies voltage to one of two resistive films, and which detects voltage corresponding to where operation was performed on the other resistive film, (iv) a surface acoustic wave type which detects rebounding of an oscillatory wave with voltage variations of a piezo-electric element, to detect the touch of a fingertip, etc, (v) an infrared ray type which detects the touch position of a fingertip, etc, based on the obstruction of infrared rays, and (vi) an optical sensor type with optical sensors grouped on a screen, which detects a touch position, can be used.

(10) The structural elements described in the embodiment may be actualized with an integrated circuit with a single chip or a plurality of chips, or with a computer program, or with any other form.

Also, the structural elements described in the embodiment may have their functions actualized in cooperation with the processor held by the mobile phone device.

(11) The program for actualizing the process of the control processing of the mobile phone device (See FIG. 9) that was explained in the embodiment may be circulated and distributed by being recorded onto a recording medium or by using various kinds of data transmission channels, etc. The recording medium may be an IC card, a hard disk, an optical disk, a flexible disk, ROM, flash memory, etc. The functions of the mobile phone device displayed in the embodiment can be actualized with the carrying out of the circulated and distributed program by a processor which uses the circulated and distributed program, along with being stored in a memory, etc, readable with the processor of the equipment.

(12) The mobile phone device pertaining to the embodiment may incorporate part or all of the above modifications (1) to (11).

(13) The following is a further explanation of the structure, modification examples and effects of the mobile terminal pertaining to the embodiment of the present application.

(a) the mobile terminal pertaining to the embodiment of the present application comprises; a mobile terminal that receives as a target of processing, one display object selected by a touch operation from a plurality of display objects, the mobile terminal comprising: a display that shows a primary image including the plurality of display objects; a detection unit that detects the touch operation on the display; a display control unit that displays, on the display, a secondary image including at least two representative display objects, that respectively represent display objects displayed in a predetermined range of a first touch position where the touch operation has been performed, and that are arranged around the first touch position, and a reception unit that, when a moving touch operation is detected to move from the first touch position to a second touch position after the secondary image has been displayed, identifies one representative display object located on the second touch position, and receives as the target of processing, one display object represented by the one representative display object.

The mobile terminal displays, on the display, the secondary image including representative display objects which respectively represent multiple display objects being displayed within a predetermined range of the first touch position, when a touch operation is performed in the vicinity of the display position of the desired display object on the primary image which has arranged thereon multiple display objects identifiable to a viewing user.

Accordingly, with the mobile terminal, even when the display size of the display objects arranged on the primary image are comparatively small, it is possible to increase the possibility of displaying a representative display object which represents the display object desired by a user. Accordingly, a user is able to swiftly select their desired display object that is represented by one displayed representative display object.

Also, the mobile terminal arranges the multiple representative display objects on the secondary image around the first touch position, in other words, the position of the touch operation performed on the display by a user. Due to this, it is possible to efficiently select the desired display object represented by one representative display object within a generally low number of operations.

(b) The plurality of display objects may be a plurality of keys disposed so as to form a software keyboard, and the secondary image has arranged therein multiple representative keys which represent (i) the key displayed in the first touch position and (ii) one or more keys located within the predetermined range of the location of the key displayed in the first touch position.

With the mobile terminal, even though the size of the keys which form the software keyboard may be comparatively small, it is possible to increase the likelihood of being able to display a representative display object which represents the key desired by a user. Therefore, a user is able to swiftly select their desired display object.

(c) In addition, the representative display objects may be positioned equidistantly from the first touch position.

The mobile terminal arranges the multiple representative display objects equidistantly from the first touch position, therefore, no matter which key represented by a representative display object a user selects, the degree of operation (the drag operation movement) is fixed, allowing for smooth operations to be actualized.

(d) The representative display objects may be positioned circumferentially on an approximate circle with the first touch position as a central point of the approximate circle, and the representative key which represents the key displayed in the first touch position may be located above the first touch position and along the circumference of the approximate circle.

When a representative display object is arranged on a location below the first touch position, generally, it is feasible that the representative display object will be more likely to be obscured by the user's hand when performing a touch operation, and thus be difficult to find, than it would be for a representative display object arranged above the first touch position.

The mobile terminal is able to arrange a representative display object representing a key displayed on the first touch position, that is believed to have a high probability of selection by the user, on a location above the first touch position where it is easily viewable to the user.

(e) When a plurality of other keys are located within the predetermined range of the key displayed in the first touch position, the multiple representative keys which represent the plurality of other keys may be arranged on the approximate circle in increasing polar coordinate order with respect to the pole, which is the first touch position, and the angle to the center of each of the keys.

With the mobile terminal, when a plurality of other keys are located within the predetermined range of the key displayed in the first touch position, the multiple representative keys which represent the plurality of other keys may be arranged in increasing polar coordinate order with respect to the pole, which is the first touch position, and the angle to the center of each of the keys.

Accordingly, the relative position of the plurality of other keys relative to the key displayed on the first touch position, is reflected in the order of the display of the multiple representative display objects representing the plurality of other keys. Therefore, the mobile terminal displays the representative display objects which represent the key desired by the user in such a way that the key is comparatively easy to locate.

(f) In addition, the detection unit may detect, as the touch operation, an elapse of a predetermined time while a touch on the display continues, and after the secondary image has been displayed, and when a touch is released at the second touch position, the reception unit may identify the representative display object shown at the second touch position as the one representative display object, and the display control unit may erase the secondary image once the reception unit has identified the one representative display object, and when a touch is released after the touch on the display has begun and before the predetermined time has elapsed, the reception unit may further receive, as the target of processing, one display object displayed in the touch position of the touch on the display.

The mobile terminal selects, as the target of processing, the display object represented by the representative display object displayed on the position where a user's touch was released (the second touch position).

Accordingly, a user can select their desired display object by performing one continuous operation wherein the user initiates a touch near the display position of their desired display object (the first touch position), then after the predetermined time for the touch is equaled or exceeded, moves (drag operation) their fingertip, etc, to the position (the second touch position) on the displayed secondary image where the representative display object is displayed that represents the user's desired display object, the user then releasing the touch.

Also, with the mobile terminal, a user can, by altering the touch time, easily choose whether or not to bring up the secondary image and select their desired display object. In other words, for example, when a user wishes to select a display object that has a relatively large display size without bringing up the secondary image, by performing a touch operation so brief as to not elapse the predetermined time frame, then the desired display object may be selected without bringing up the secondary image.

(g) As well, the size of the representative display objects may be enlarged from the display size of the display objects which the representative display objects represent.

Because the multiple representative display objects of the mobile terminal have been enlarged from the size of the display objects they represent, even when the display size of the display objects is small, a user is able to accurately select one representative display object that represents their desired display object from among the enlarged representative display objects.

(14) The display of the mobile terminal of the present invention corresponds to, for example, the display 110 of the mobile phone device 100 pertaining to the embodiment, and the detection unit, display control unit and reception unit of the mobile terminal of the present invention correspond to the detection unit 141, the display control unit 142, and the reception unit 143, respectively, of the mobile phone device 100 pertaining to the embodiment.

### INDUSTRIAL APPLICABILITY

The mobile terminal of the present invention is useful in selecting a display object from a plurality of display objects displayed on a display with a touch operation performed by a user.

### REFERENCE SIGNS LIST

1 Main casing
100 Mobile phone device
110 Display
112 Touchpad
113 Controller
120 Timer unit
130 Memory unit
140 Control unit
141 Detection unit
142 Display control unit
143 Reception unit
144 Execution unit

1. A mobile terminal that receives as a target of processing, one display object selected by a touch operation from a plurality of display objects, the mobile terminal comprising:
a display that shows a primary image including the plurality of display objects;
a detection unit that detects the touch operation on the display;
a display control unit that displays, on the display, a secondary image including at least two representative display objects, that respectively represent display objects displayed in a predetermined range of a first touch position where the touch operation has been performed, and that are arranged around the first touch position, and
a reception unit that, when a moving touch operation is detected to move from the first touch position to a second touch position after the secondary image has been displayed, identifies one representative display object located on the second touch position, and receives as the target of processing, one display object represented by the one representative display object.

2. The mobile terminal of claim 1, wherein
the plurality of display objects are a plurality of keys disposed so as to form a software keyboard, and
the secondary image has arranged therein multiple representative keys which represent (i) the key displayed in the first touch position and (ii) one or more keys located within the predetermined range of the location of the key displayed in the first touch position.

3. The mobile terminal of claim 2, wherein
the representative display objects are positioned equidistantly from the first touch position.

4. The mobile terminal of claim 3, wherein
the representative display objects are positioned circumferentially on an approximate circle with the first touch position as a central point of the approximate circle, and
the representative key which represents the key displayed in the first touch position is located above the first touch position and along the circumference of the approximate circle.

5. The mobile terminal of claim 2, wherein
when a plurality of other keys are located within the predetermined range of the key displayed in the first touch position, the multiple representative keys which represent the plurality of other keys are arranged on the approximate circle in increasing polar coordinate order with respect to the pole, which is the first touch position, and the angle to the center of each of the keys.

6. The mobile terminal of claim 1, wherein
the detection unit detects, as the touch operation, an elapse of a predetermined time while a touch on the display continues,
after the secondary image has been displayed, and when a touch is released at the second touch position, the reception unit identifies the representative display object shown at the second touch position as the one representative display object,
the display control unit erases the secondary image once the reception unit has identified the one representative display object, and
when a touch is released after the touch on the display has begun and before the predetermined time has elapsed, the reception unit further receives, as the target of processing, one display object displayed in the touch position of the touch on the display.

7. The mobile terminal of claim 1, wherein
the size of the representative display objects has been enlarged from the display size of the display objects which the representative display objects represent.

8. A reception control method for controlling reception of a target of processing of a mobile terminal that receives as the target of processing, one display object selected by a touch operation from a plurality of display objects displayed on a display which the mobile terminal includes, the reception control method comprising the steps of:
Detecting the touch operation on the display;
displaying, on the display, a secondary image including at least two representative display objects, that respectively represent display objects displayed in a predetermined range of a first touch position where the touch operation has been performed, and that are arranged around the first touch position, and
identifying, when a moving touch operation is detected to move from the first touch position to a second touch position after the secondary image has been displayed, one representative display object located on the second touch position, and receiving as the target of processing, one display object represented by the one representative display object.
